(19) United States
(12) Patent Application Publication
(10) Pub. No.: US 2006/0133992 A1
(43) Pub. Date: Jun. 22, 2006

(54) Hydrocarbon fuel processor and fuel useable therein

(75) Inventor: Gunther H. Dieckmann, Walnut Creek, CA (US)

Correspondence Address: CHEVRON TEXACO CORPORATION, P.O. BOX 6006, SAN RAMON, CA, 94583-0806, US

(73) Assignee: Chevron U.S.A. Inc.

(21) Appl. No.: 11/015,832

(22) Filed: Dec. 16, 2004

(51) Int. Cl. C01B 3/26

(52) U.S. Cl. 423/651

(57) ABSTRACT

A process for autothermal reforming of a hydrocarbon fuel to produce hydrogen for use in a fuel cell. The process requires the hydrocarbon fuel passed over a Group VIII metal catalyst on a solid support be low in sulfur content, have an octane of at least 60 and have an aromatics+naphthenes content of less than 70 volume %.

### BACKGROUND OF THE INVENTION

Fuel cells are becoming increasingly important for the generation of electrical energy for various uses. Hydrogen is one of the important fuels used in many fuel cells such as PEM (proton exchange membrane) fuel cells, solid oxide fuel cells, molten carbonate fuel cells and other fuel cells. Hydrogen generation and hydrogen containment are still challenges in the development of fuel cell systems. In particular fuel cells vehicles are being developed as an alternative to internal combustion engine powered vehicles. While demonstration fuel cell vehicles have been built that use compressed hydrogen, or liquid hydrogen, it may be more practical to generate hydrogen for the fuel cell vehicle by reforming methanol or more readily available fuels, such as jet, diesel, gasoline, or other hydrocarbons available from chemical or petroleum processing plants in an on-board reformer; thereby, avoiding the need to compress and store the hydrogen in expensive high pressure carbon fiber tanks or cryogenic Dewars and the need to centrally generate and store large quantities of hydrogen. In a hydrocarbon reformer, the hydrocarbon fuel is blended with steam and/or air before being passed over a reformer catalyst to produce hydrogen and carbon monoxide. The reformer catalyst can consist of Ni, Pt, and/or other platinum group metals supported on for example alumina, zirconia, cordierite, or alumina or zirconia coated cordierite, and is often additionally promoted with alkaline earth or rare earth oxides. Additional hydrogen can be generated by passing the product gases from the reformer catalyst bed over a water gas shift catalyst bed. This subsequent hydrogen rich stream may also pass over a selective oxidation catalyst to reduce the residual carbon monoxide to an acceptable level. The purified hydrogen rich stream is then fed to a PEM (proton exchange membrane) fuel cell stack, where the hydrogen combines with oxygen, typically from air, to produce electric power for a motor.

One of the major problems with generating hydrogen for a fuel cell vehicle in an on-board reformer is that the reformer must consume a minimum amount of fuel upon start-up and be able to handle large dynamic load swings in seconds. The reformer catalyst typically operates at a temperature above 600 C. and more preferably above 650 C. and even more preferably above 700 C., thus it is critical to minimize both the weight and volume of the reformer catalyst. Consequently, highly desirable fuels for fuel cell vehicles are those hydrocarbon fuels that are easily reformed, thus minimizing the amount and volume of reformer catalyst.

The patent literature provides some guidance toward this goal. World Patent Application, WO98/08771 (PCT/US97/14906) assigned to A. D. Little teaches that fuel cell fuels can include distillate fuels, gasoline, and alcohols. World Patent, WO 00/39873 (PCT/US99/30264) assigned to International Fuel Cells, LLC teaches that since gasoline is the most generally available fuel for vehicle use that gasoline is also the most desirable fuel for a fuel cell powered vehicle provided that the sulfur compounds in the gasoline are reacted over a nickel containing adsorbent prior to reforming. The ‘39873’ application recognizes that when there are very few fuel cell vehicles on the road, the obvious fuel will be gasoline. However as the number of fuel cell vehicles on the road increase, it may become economically feasible to generate, distribute and market a more desirable fuel cell fuel other than gasoline. ‘39873’ does not teach what this more desirable fuel could be.

World Patent, W0200144412 assigned to Idemitsu Kosan Co, teaches that a desulfurized light naphtha for a fuel cell reformer should have a weight ratio of iso-paraffins to normal paraffins of at least one. JP2001279271 also assigned to Idemitsu Kosan teaches that 90 volume percent of the fuel should have a boiling range between 140 to 270 C. (284 to 518 F.), have a molar ratio of carbon to hydrogen in the mixture of 0.5 or less, and be free of aromatic compounds. In other words, a fuel cell fuel should preferably contain paraffins, which have a carbon to hydrogen ratio of less than 0.5. Mono-olefins, such as 1-octene for example, and naphthlenes such as methyl cyclohexane have a carbon to hydrogen ratio of exactly 0.5, and thus would also be permitted. World Patent, WO01 82401 assigned to Idemitsu Kosan CO teaches that a fuel with a density of 0.60 to 0.72 g/cm³ at 15 C, a surface tension at 20 C. of 170 to 250 mN/cm and an octane value of 70 or more can be used in both an internal combustion engine as well as a fuel cell vehicle. Though not directly obvious, limiting the density of the fuel to be between 0.60 and 0.72 g/cm³ excludes conventional gasoline, where the density is normally between 0.72 and 0.78 g/cm2 due to the presence of higher density aromatic and naphthenic compounds. Thus WO01 82401 teaches that the preferred fuel is rich in paraffins and possibly olefins. However one of the peculiar aspects of WO01 82401 is that it teaches that the octane rating of the fuel should be greater than 70 and more preferably greater than 80 in order for the fuel to be used in both internal combustion engines as well as fuel cell vehicles. This octane requirement according to “401” is to prevent knocking in internal combustion engines. However modern high compression internal combustion engines require hydrocarbon fuels with an octane rating of 87 to 93. WO0182401 never teaches that octane is an important parameter in selecting a fuel for a fuel cell vehicle.

It would be advantageous to have a process for reforming hydrocarbons to hydrogen and a fuel specifically designed for the process that can achieve nearly complete conversion of the fuel and avoids undesirable byproduct formation. The present invention provides such a process and fuel.

### SUMMARY OF THE INVENTION

The present invention provides a process for autothermal reforming of a hydrocarbon fuel to produce hydrogen for use in a fuel cell, comprising:
passing a hydrocarbon fuel having a total sulfur content of less than 30 ppm by weight, a (R+M)/2 octane rating of at least 60, and a aromatics +naphthenes content of less than 70 volume % over a catalyst comprising a Group VIII metal on a solid support, at reforming conditions with an oxygen (as O) to carbon ratio of greater than 0.7, to produce an effluent comprising hydrogen; and using at least a portion of the effluent comprising hydrogen in a fuel cell to produce electricity.

Among other factors we have found that the composition of the fuel used in an autothermal reformer to make hydrogen for use in a fuel cell must have particular properties in order to be readily reformed and to avoid undesirable byproduct formation. In particular the fuel used in the process of the present invention must be low in sulfur, should have an (R+M)/2 octane rating between about 60 and 85, preferably between 75 and 85, and have an aromatic+naphthenes content of no greater than 70 vol. %. Preferably the fuel should have no more than about 1 volume percent of oxygenate containing compounds. Surprisingly, I have found that the octane of the fuel is a critical feature in the performance of the fuel in an autothermal reformer. Fuels having an octane below about 60 performed poorly in the process of the present invention. The low octane fuels tended to have unacceptably high conversion to light hydrocarbons such as methane, ethane, etc. and resulted in decreased H₂ yield and fouling of the preferred catalyst and downstream process components in the process of the present invention. There appeared to be no advantage in the autothermal reformer to having an octane above about 85 thus for cost reasons it is desirable to keep the octane level of the fuel below about 85. Oxygentated species also tended to have a negative effect on the performance of the fuel in the autothermal reformer. Thus I have determined that oxygenated species in the fuel should be kept to below about 1 volume percent.

### DETAILED DESCRIPTION OF THE INVENTION

The present invention provides a novel process for the autothermal reforming of liquid hydrocarbons to form hydrogen for use in a fuel cell to make electricity. The process comprises passing a hydrocarbon fuel having a total sulfur content of less than 30 ppm by weight, a (R+M)/2 octane rating of at least 60, and a aromatics+naphthenes content of less than 70 volume % over a catalyst comprising a Group VIII metal on a solid support, at reforming conditions with an oxygen (as O) to carbon ratio of greater than 0.7, to produce an effluent comprising hydrogen.

I have discovered that low sulfur oxygenate free hydrocarbons are most easily reformed in an autothermal reformer when the antiknock index (R+M)/2 or octane rating of the fuel is greater than 60 and more preferably greater than 75. This is actually quite surprising since the antiknock index is a measure of the fuels ability to resist “knocking” caused by autoignition in an internal combustion engine. The higher the octane rating of the fuel the less likely the fuel will ping or knock under high compression conditions. Modern internal combustion engines require fuels with an antiknock index or octane rating of greater than 85 and more preferably from 87 to 93. Thus it is completely surprising that the “reformability” of a fuel in an autothermal reformer should depend upon a rating developed for a completely different engine. The octane number of the fuel can be determined by ASTM test method D 2885.

Furthermore I have found that variations in the concentration of paraffins, olefins, aromatics and naphthenic compounds in a fuel cell fuel run under specific autothermal conditions have very little impact on the reformability of the fuel provided that the aromatic content or naphthenic content of the fuel is less than about 70 volume % and more preferably less than 60 vol %, and that the fuel contains low levels of or is free of oxygen containing compounds. I have surprisingly found that the addition of ethanol to gasoline reduces the ability of gasoline to be easily reformed.

Low sulfur hydrocarbon fuels are those fuels with a boiling range from about 0 to about 480 F and more preferably from about 32 to 430 F with a sulfur content of less than about 30 ppm sulfur, preferably less than 10 ppm S, and even more preferably less than 5 ppm S and most preferably less than 1 ppm S. Sources of low sulfur hydrocarbon fuels include but are not limited to, butanes, pentanes, hexanes, hydrotreated FCC gasoline, hydrotreated gasoline, hydrotreated straight run naphtha, reformate, alkylate, hydrocracked naphtha, ethylene steam cracker gasoline, hydrotreated ethylene steam cracker gasoline, hydrocarbons from a Fischer-Tropsch gas to liquids plant, hydrotreated gas condensates and/or combinations thereof. High sulfur fuels containing more than 30 ppm sulfur rapidly poison many reformer catalysts. High sulfur feeds can be used in a fuel cell reformer, if the feed is first passed over a sulfur removal system, such systems include but are not limited to mild hydroprocessing as taught for example in U.S. Pat. No. 6,475,376 or nickel adsorbents such as taught in World Patent, WO 00/39873 (PCT/US99/30264). The hydrocarbons produced by a Fischer-Tropsch (FT) gas to liquids process are particularly well suited as a component for the fuel for autothermal reforming process of the present invention because they are typically low in sulfur which is also a requirement for the fuel used in the present invention. However FT hydrocarbon cuts are also typically very low in octane being comprised predominantly of highly linear hydrocarbon chains. Most FT hydrocarbon cuts would require addition of high octane components (such as toluene) to be suitable for use as a fuel in the autothermal reforming process of the present invention. FT cuts may also have to be treated to remove high levels of oxygenates that may be formed in the FT process.

FT hydrocarbon cuts can be upgraded to make fuel components having higher autoignition temperatures by various means. One such means includes catalytic reforming of FT material (such as naphtha) to make a product having increased aromatic content. A process that discloses naphtha reforming of a FT effluent is U.S. Pat. No. 6,693,138 which is herein incorporated by reference in its entirety.

As mentioned above oxygentated species also tended to have a negative effect on the performance of the fuel in the autothermal reformer. Thus I have determined that oxygenated species in the fuel should be kept below about 5 percent, preferably below 3 percent, and more preferably below about 1 volume percent. Oxygen containing compounds or oxygenates include methanol, ethanol, iso-propanol, methyl tert-butyl ether, ethyl tert-butyl ether, tert-amyl methyl ether, etc. Levels of oxygenate containing compounds greater than about 1 volume percent start to decrease the “reformability” of a hydrocarbon fuel.

Autothermal reforming is a process where a hydrocarbon stream is mixed with an oxygen containing stream and steam prior to contacting a reforming catalyst. In autothermal reforming, the oxygen (as atomic O) to carbon ratio is in the range of 0.5 to 1.0 and more preferably in the range of 0.7 to 0.9 with a steam to carbon ratio of 0.5 to 3.0 and more preferably 1.0 to 2.2 in the final mixed hydrocarbon/steam/oxygen containing stream. It is important in autothermal reforming of hydrocarbons to avoid pre-ignition or pre-burning of the hydrocarbon fuel prior to contact with the reformer catalyst. This is accomplished by either by injecting the hydrocarbon fuel into a heated steam/air stream into a region just in front or above the reformer catalyst. Or by injecting air into the steam/hydrocarbon stream into the region just in front or above the reformer catalyst. Pre-ignition or pre-burning is normally not a problem in a vehicle reformer due to the engineering necessity of minimizing the weight and volume of the hydrocarbon reformer in order to minimize fuel consumption upon startup as well as improve the response time to dynamic load changes.

Not to be limited by theory, I believe that the more the fuel is pre-burned or pre-oxidized prior to contacting the reformer catalyst, the harder it is to reform. Thus high octane fuels, which are not as easily oxidized, also turn out to be the easiest fuels to reform. Thus the addition of oxygenated species such as ethanol suppresses the reformability of a hydrocarbon fuel. In contrast to the prior art which found that paraffins are the most preferred fuel cell fuels, I have found that any combination of paraffins, olefins, naphthenes, and aromatic compounds are acceptable provided that the aromatic or naphthenic content does not exceed about 70 volume percent and more preferably 60 volume percent of the fuel. Not to be limited by theory, I believe that the flexibility in fuel composition is the result of the high temperature flame front created by the partial combustion of gasoline or other hydrocarbons in the front part of the reformer catalyst bed. Temperatures in the flame front can easily exceed 800 C. Thus these high temperatures allow aromatic and naphthenic compounds to be reformed. In order to achieve these high flame front temperatures, the oxygen to carbon ratio should be greater than 0.7.

Gasoline is a blend of different refinery process streams. Likewise the ideal fuel cell fuel can be a blend of different refinery and other hydrocarbon processing streams provided that the antiknock index or octane rating of the fuel is greater than 60 and more preferably greater than 70, and that the aromatic or naphthenic content of the fuel not exceed 70 vol % and more preferably 60 volume %. Since sulfur is poison to the fuel cell stack as well as the reformer catalyst, it is highly desirable to create fuel cell fuels from low sulfur streams. Refinery streams that can be blended together to create ideal fuel cell fuels include but are not limited to, butanes, pentanes, hexanes, FCC gasoline, hydrotreated FCC gasoline, straight run naphtha, hydrotreated straight run naphtha, reformate, alkylate, hydrocracked naphtha, and hydrotreated light distillate. Other hydrocarbon sources that can also be blended together or used straight in fuel cell reformers for vehicles include, hydrotreated natural gas condensates, ethylene steam cracker gasoline, and hydrotreated ethylene steam cracker gasoline. Thus easy to reform hydrocarbon fuels can be prepared by blending together low octane streams such as hydrotreated straight run naphtha and hydrotreated natural gas condensates with high octane streams such as reformate, alkylate, or even hydrotreated FCC gasoline. It is desirable that the blended hydrocarbon fuel have an octane rating greater than 60 and more preferably greater than 75. However since hydrocarbon fuels with an octane rating greater than 85 are used in internal combustion engines, it would be desirable to limit the amount of high octane components in fuel cell fuels. Thus a practical fuel cell fuel may have an octane rating ranging from 60 to about 85 and more preferably from about 75 to 85.

As mentioned above catalysts useable in the process of the present invention are sensitive to sulfur contamination and particularly sulfur in the hydrocarbon feed. Thus in the process of the present invention the hydrocarbon fuel fed to the reformer should have a sulfur content of less than about 30 ppm sulfur, preferably less than 10 ppm S, more preferably less than 5, most preferably less than 1 ppm S.

### EXAMPLES

### Example 1

### Reformability of Fuels

To rank the “reformability” of various hydrocarbon fuels, a small scale test apparatus was built in which the test fuel was sprayed through an 8 micron orifice into a 500 C. steam swept chamber at a steam to carbon mole ratio of 2.0. This fuel/steam mixture was then blended with air at an oxygen (as O) to carbon ratio of 0.8 approximately 18 cm above the catalyst bed. The fuel/steam/air stream then passed through 0.25 grams of a Ni-based reformer catalyst held at 750 C. in a furnace. After condensing the excess water from the product gases, the concentration of hydrogen, carbon monoxide, carbon dioxide, nitrogen, methane, and any additional hydrocarbons was measured using a Wasson gas chromatograph.

### Example 2

### Reformability of Several Fuels

This example shows the reformability of several fuels having different compositions using the protocol of example 1. Table 1 shows the yield of hydrocarbons as the mole % of carbon in the hydrocarbon feed at 10 weight hourly space velocity based on the weight of hydrocarbon feed. A low yield of hydrocarbons indicates that the feed was easily reformed.

As can be easily seen from Table 1, the reformability of the fuel is dependent upon the octane rating and not upon the concentrations of paraffinic, olefinic, naphthenic, and/or aromatic compounds in the fuel. The exception to the octane rating was pure methyl cyclohexane and the ethanol containing fuel.

TABLE 1
Reformability of Various Hydrocarbon Fuels

| | | n-Paraffin | Isoparaffin | Olefin | Naphthenes | Aromatic | Oxygenate | | Hydrocarbon |
|---|---|---|---|---|---|---|---|---|---|
| | Sulfur | Content | Content | Content | Content | Content | Content | Octane | Yield |
| Hydrocarbon/Cut | ppm | Vol % | Vol % | Vol % | Vol % | Vol % | Vol % | (R + M)/2 | Mole % |
| n-Heptane | 0.03 | 100 | 0 | 0 | 0 | 0 | 0 | 0 | 2.7 |
| Methylcyclohexane | 0.04 | 0 | 0 | 0 | 100 | 0 | 0 | 73 | 1.8 |
| Hydrotreated straight | 0.04 | 32 | 38 | 0 | 21 | 9 | 0 | 56 | 1.6 |
| run naphtha | | | | | | | | | |
| Hydrotreated FCC | 0.05 | 32 | 0 | 1 | 14 | 53 | 0 | 82 | 0.95 |
| heavy gasoline | | | | | | | | | |
| Hydrotreated gasoline | 0.4 | 11 | 59 | 1.0 | 9 | 20 | 0 | 85 | 1.0 |
| Hydrotreated gasoline | 0.1 | 11 | 49 | 0.7 | 11 | 28 | 0 | 84 | 1.0 |
| Hydrotreated gasoline | 0.1 | 10 | 47 | 0.7 | 11 | 26 | 5 | 85 | 1.8 |
| with 5% ethanol | | | | | | | | | |

What is claimed is:

1. A process for autothermal reforming of a hydrocarbon fuel to produce hydrogen for use in a fuel cell, comprising:
passing a hydrocarbon fuel having a total sulfur content of less than 30 ppm by weight, a (R+M)/2 octane rating of at least 60, and a aromatics+naphthenes content of less than 70 volume % over a catalyst comprising a Group VIII metal on a solid support, at reforming conditions with an oxygen (as O) to carbon ratio of greater than 0.7, to produce an effluent comprising hydrogen; and
using at least a portion of the effluent comprising hydrogen in a fuel cell to produce electricity.

2. The process of claim 1 wherein the hydrocarbon fuel further comprises less than 5 volume percent of oxygenate containing compounds.

3. The process of claim 1 wherein the Group VIII metal is selected from the group consisting of Pt, Pd, and Ni.

4. The process of claim 1 wherein the autothermal reforming is carried out onboard a fuel cell powered vehicle.

5. The process of claim 1 wherein the hydrocarbon fuel has an (R+M)/2 octane rating of between 60 and 85.

6. The process of claim 3 wherein the Group VIII metal is Ni.

7. The process of claim 1 wherein the hydrocarbon feed has a total sulfur content of less than 5 ppm by weight.

8. The process of claim 1 wherein the hydrocarbon fuel further comprises less than 3 volume percent of oxygenate containing compounds.

9. The process of claim 1 wherein the hydrocarbon fuel further comprises less than 1 volume percent of oxygenate containing compounds.

10. The process of claim 1 wherein at least a portion of the hydrocarbon fuel is derived from a Fischer-Tropsch gas to liquids process.

11. The process of claim 1 wherein supplemental aromatic hydrocarbons are added to the hydrocarbon fuel.
